(19) United States
(12) Patent Application Publication
(10) Pub. No.: US 2015/0274561 A1
(43) Pub. Date: Oct. 1, 2015

(54) METHODS OF REDUCING SCALANT FORMATION

(71) Applicants: Oy J. KEMIRA, (US); Lucas MOORE, Marietta, GA (US)

(72) Inventors: Lucas Moore, Marietta, GA (US); Rosa Carceller, Espoo (FI)

(21) Appl. No.: 14/436,119

(22) PCT Filed: Oct. 11, 2013
(86) PCT No.: PCT/US13/64469

§ 371 Date: Apr. 16, 2015

Related U.S. Application Data
(60) Provisional application No. 61/716,018, filed on Oct. 19, 2012.

(51) Int. Cl. C02F 5/12; C02F 1/44; C02F 1/68

(52) U.S. Cl. CPC C02F 5/12; C02F 1/683; C02F 1/441; C02F 2103/08

(57) ABSTRACT

Embodiments of the present disclosure provide for compositions, methods of reducing scale, and the like. In an embodiment a method can include adding the composition, as described herein, to a desalination system in need of scale treatment, in an amount effective to reduce scale formation in the desalination system.

### CLAIM OF PRIORITY TO RELATED APPLICATION

This application claims priority to co-pending U.S. provisional application entitled “METHODS OF REDUCING SCALANT FORMATION” having Ser. No.: 61/716,018, filed on Oct. 19, 2012, which is entirely incorporated herein by reference.

### BACKGROUND

Removing scale and mineral deposits is a common and serious problem for many industries, including the oil, mining, and paper industries. Scale inhibiting agents are commonly used to address this problem. However, environmental concerns have called into question many commonly used chemicals. Thus, there is a need to overcome these deficiencies and address these problems.

### SUMMARY

Embodiments of the present disclosure provide for methods of reducing calcium carbonate and calcium sulfate scale in a desalination system.

An exemplary embodiment of a method of reducing calcium carbonate and calcium sulfate scale in a desalination system, among others, includes: disposing a composition in an aqueous solution in the desalination system, wherein the composition includes an active substance that is a carboxylated polymer that has been neutralized with an organic amine; and inhibiting the formation of a scale on the one or more surfaces of the desalination system, wherein the scale is selected from the group consisting of calcium carbonate, calcium sulfate, and a combination thereof

Other systems, methods, features, and advantages will be, or become, apparent to one with skill in the art upon examination of the following drawings and detailed description. It is intended that all such additional structures, systems, methods, features, and advantages be included within this description, be within the scope of the present disclosure, and be protected by the accompanying claims.

### DETAILED DESCRIPTION

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, synthetic organic chemistry, paper chemistry, and the like, which are within the skill of the art. Such techniques are explained fully in the literature.

The examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms and phrases that shall be defined to have the following meanings unless a contrary intention is apparent.

### General Discussion

Embodiments of the present disclosure provide for compositions, methods of reducing scale, and the like. In an embodiment a method can include adding the composition, as described herein, to a desalination system in need of scale treatment, in an amount effective to reduce scale formation in the desalination system. In particular, embodiments of the present disclosure can be used to inhibit the formation of calcium carbonate and/or calcium sulfate on surfaces of a desalination system. In addition to being effective at inhibiting the formation of scale, the composition is partially biodegradable, which offers an advantage over other similar compositions since the composition has less of an environmental impact and/or less buildup of the composition in the desalination system.

In an embodiment, the method can be used to reduce the amount of scale formed in a desalination system. An embodiment of a composition of the present disclosure can be disposed (e.g., introduced to or mixed with) in an aqueous solution in a desalination system. The composition can inhibit the formation of scale on the one or more surfaces of the desalination system, in particular, the formation of calcium carbonate and/or calcium sulfate scale. In general, the composition is continuously dosed into the aqueous solution of the desalination system and can be used to inhibit the formation of the scale for extended periods of time. In an embodiment where the composition is not continuously disposed in the desalination system, the composition can be added to the aqueous solution to inhibit the formation of the scale as needed. In reverse osmosis desalination the dosing point can be anywhere before the reverse osmosis membrane, but in an embodiment the dosing point can be before the high pressure pump.

The term “inhibit” refers to the ability of the composition to reduce the amount of scale formed and/or the rate of formation of the scale on the surfaces of the desalination system relative to a desalination system where the composition has not been introduced.

As mentioned above, the composition is partially biodegradable over a certain time frame. Biodegradable is defined as the capability of being broken down into simple, non-toxic material by the action of microorganisms and/or fungi. Being partially biodegradable limits the build-up of chemicals in the desalination system and/or environment. The phrase “partially biodegradable” refers to the composition being broken down by about 40% or more, about 50% or more, or about 60% or more, over in 28 days, as compared to the amount originally used. In the standardized test mentioned below, each week the biodegradability is being tested (days 7, 14, 21 and 28), and the method achieves greater than about 50% biodegradability at 28 days. Biodegradability is measured using the Organization for Economic Cooperation and Development (OECD's) 306 test for biodegradability that is currently used at the time of filing.

In general, the amount of the composition that is effective to reduce scale in a particular desalination system may be determined by routine experimentation in light of the guidance provided herein. The amount of the composition disposed in the desalination system may vary over a broad range, depending on the nature of the desalination system, rate of scale formation, the amount of calcium present, the temperature, the pH, water circulation or flow, the type of material used to make the various parts of the desalination system, the design of the desalination system, and the like. Consequently, the concentration of the composition in the aqueous solution can be adjusted depending upon the desalination system and environment of the where the composition is being used. For example, the amount of an active substance of the composition added to the desalination system may be about 0.5 part per million to 50 parts per million or about 1 to 10, by weight based on the capacity of the desalination system.

In an embodiment, the composition includes an active substance that is a carboxylated polymer that has been neutralized with an organic amine, water, and optionally other components. In an embodiment, the neutralized carboxylated polymer is in an aqueous solution having a pH at least 6.0 or about 6.0 to 6.9. In an embodiment, the active substance can be about 30 to 60 weight % of the composition. In an embodiment, the polymer in the composition has a molecular weight of about 500 to 10,000 Daltons about 1000 to 6000 Daltons, or about 1000 to 4000 Daltons.

In an embodiment, the carboxylated polymer refers to a polymer, a homopolymer or a copolymer, that contains one carboxylic acid group (COOH) or repeating carboxylic acid groups.

In an embodiment, a carboxylated polymer can be made by free-radical polymerization, preferably by solution polymerization in water. In an embodiment, polymerization reactions described herein can be initiated by a means that results in generation of a suitable free-radical. Thermally derived radicals, in which the radical species results from thermal, hemolytic dissociation of an azo, peroxide, hydroperoxide, and perester compounds are preferred. In an embodiment, the initiators can include azo compounds such as 2,2′-azobis(2-amidinopropane) dihydrochloride, 2,2′-azobis[2-(2-imidazolin-2-yl)propane] dihydrochloride, 2,2′-azobis(isobutyronitrile) (AIBN), 2,2′-azobis(2,4-dimethylvaleronitrile) (AIVN), and the like.

When the process employs as a polymerization initiator to form the carboxylated polymer, a redox system including at least one initiator and at least one water soluble salt used as reductant can be used. In an embodiment, the water soluble salts are susceptible to oxidation by oxidants typically used in redox catalyst as polymerization initiators. In an embodiment, the initiators can include hydrogen peroxide, benzoyl peroxide, sodium persulfate and sodium persulfate bisulfite, t-butyl hydroperoxide, cumene hydroperoxide, dialkylperoxide, ammonium persulfate and ammonium persulfate/bisulfite, and a combination thereof.

When the carboxylated polymer is a polyacrylic acid co-polymer, anionic or non-ionic monomers can be used as co-monomers. In an embodiment, the anionic co-monomers can include methacrylic acid, maleic acid, maleic anhydride, itaconic acid, fumaric acid, alpha-hydroxyacrylic acid, crotonic acid, citraconic acid, aconite acid, 2-acrylamido-2-methyl-1-propanesulfonic acid, styrene sulfonic acid, vinyl phosphonic acid, allyl sulfonic acid, allyl phosphonic acid-and mixtures thereof. In an embodiment, nonionic monomers can include acrylamide, methacrylamide, N-isopropylacrylamide, N-t-butylacrylamide, N-methylolacrylamide, hydroxyethylmethacrylate, vinyl acetate, vinylformamide, and mixtures thereof.

In an embodiment, the organic amine compound can include amino alcohols, primary amines, secondary amines, tertiary amines, and the like. In an embodiment, the alcohol amine compound refers to an amine having the following general formula: (R1)(R2)(OH)C—C(R3)(R4)—N(X)(Y). In an embodiment, R1, R2, R3, R4, X, and Y are nonfunctional groups that do not interfere or inhibit the neutralization of the carboxylated polymer. In an embodiment, R1, R2, R3, R4, X and Y can be hydrogen, a hydrocarbon group, for instance, having the formula (CₙH₂ₙ₊₁ wherein n=0, 1, 2 . . . ), or another chemical group that, again, does not interfere or inhibit the process and objectives of the present disclosure. As shown, the organic amine can be a primary, a secondary, or a tertiary amine. In an embodiment, R2, R3, and R4 can each be a hydrogen. In an embodiment, the amino alcohol compound can include: an ethanol amine (e.g., monoethanolamine, diethanolamine, triethanolamine, or N-methyl ethanolamine), a propanolamines (e.g., monoisopropanol amine, 2-amino-1-propanol or α-amino-n-propanol), or the like. In an embodiment, the amino alcohol is monoethanolamine, diethanolamine, or monoisopropanolamine.

In an embodiment, the carboxylated polymer can be prepared for example in a stirred reactor, operating typically at about 60 to 90° C. and filled with an appropriate amount of water that has been bubbled with nitrogen. The feeds of monomers and initiators are started at about the same time and continued for about 1-2 hours. When the feeds have ended the reaction can proceed for about ½-1 hour at the same temperature. Finally the mixture can be cooled down to about the room temperature and neutralized with an organic amine to a pH of about 6.0 or higher, typically to a pH of about 6.3 to 6.9.

In an embodiment, the carboxylated polymer can be a polyacrylic acid homopolymer, a polyacrylic acid copolymer, a maleic acid homopolymer, or a combination thereof. In an embodiment, the carboxylated polymer that has been neutralized with an organic amine is a polyacrylic acid homopolymer has been neutralized with a monoethanolamine. In an embodiment, the composition includes polyacrylic acid copolymer, where the amount of acrylic acid is about 70 mol % or more, about 85 mol % or more, about 90 mol %, about 95 mol %, or about 99 mol %.

In an embodiment, the desalination system can be a reverse osmosis desalination system. In an embodiment, the desalination system can include a thermal desalination system.

### EXAMPLES

Now having described the embodiments, in general, the examples describe some additional embodiments. While embodiments are described in connection with the examples and the corresponding text and figures, there is no intent to limit embodiments of the disclosure to these descriptions. On the contrary, the intent is to cover all alternatives, modifications, and equivalents included within the spirit and scope of exemplary embodiments.

### Example 1

A suitable four-neck glass flask fitted with a stirrer, a condenser and thermometer, is filled with 23.5 g of water. The reactor is heated and stirred until the temperature of the reactor is about 80° C., while heating, the water is bubbled with nitrogen for 30 min. Acrylic acid glacial (30.6 g) starts to be pumped during 85 min. and sodium persulfate (1.3 g) in aqueous solution (20 weight %) and sodium bisulfite (7 g) in aqueous solution (50 weight %) are pumped separately during 105 min (started simultaneously). The reaction continues at 80° C. for 30 min., after the initiator addition was finished. The reaction was kept at 60° C. for 15 min. After this, it was cooled down to room temperature and it was neutralized with 24 g of monoethanol amine. The pH after neutralization was about 6.7, the molecular weight about 1500 Dalton and the biodegradability in 28 days 64% (OECD 306).

### Example 2

A suitable four-neck glass flask fitted with a stirrer, a condenser, and thermometer, is filled with 28 g of water. The reactor is heated and stirred until the temperature of the reactor is 80° C., while heating, the water is bubbled with nitrogen for 30 min. Acrylic acid glacial (30.0 g) starts to be pumped during 85 min. and sodium persulfate (1 g) in aqueous solution (20 weight-%) and sodium bisulfite (5 g) in aqueous solution (50 weight %) are pumped separately during 105 min (started simultaneously). The reaction continues at 80° C. for 30 min., after the initiator addition was finished. The reaction was kept at 60° C. for 15 min. After this, it was cooled down to room temperature and it was neutralized with 26 g of monoethanol amine. The pH after neutralization was about 6.7, the molecular weight about 3500 Dalton and the biodegradability in 28 days 61% (OECD 306)

### Example 3

A suitable four-neck glass flask fitted with a stirrer, a condenser, and thermometer, is filled with 31.4 g of water. The reactor is heated and stirred until the temperature of the reactor is 80° C., while heating, the water is bubbled with nitrogen for 30 min. Acrylic acid glacial (31.4 g) starts to be pumped during 85 min. and sodium persulfate (1.4 g) in aqueous solution (20 weight-%) and sodium bisulfite (5.4 g) in aqueous solution (50 weight %) are pumped separately during 105 min (started simultaneously). The reaction continues at 80° C. for 30 min., after the initiator addition was finished. The reaction was kept at 60° C. for 15 min. After this, it was cooled down to room temperature and it was neutralized with 18 g of monoethanol amine. The pH after neutralization was about 6.7, the molecular weight about 2000 Dalton and the biodegradability in 28 days 64% (OECD 306).

### Example 4

338 g of deionized water was added to a 600 ml beaker. 4 ppm of polyacrylic acid that was neutralized with ethanolamine to pH 6.5-6.7 earlier was added as 1000 ppm solution which pH was adjusted to 8.5. 40 ml of NaHCO₃ solution (1.3 weight-%) and 20 ml of NH₄Cl buffer solution (10 weight-%) was added and the pH was adjusted to 8.60 (with HCl or NaOH). A turbidity probe was inserted and titration with a solution (5 weight-% CaCl₂*2H₂O) started with the speed 2 ml/minutes. Turbidity values (NTU) vs. titration time were measured and they can be seen in Table 1.

TABLE 1
Turbidity values vs. titration time.

| time | | | | |
|---|---|---|---|---|
| (min) | Blank | Ex 1 | Ex. 2 | Ex. 3 |
| 0 | 0 | 0 | 0 | 0 |
| 1 | 0.3 | 0 | 0.1 | 0 |
| 2 | 0.3 | 0 | 0 | 0 |
| 3 | 3.8 | 0 | 0.2 | 0 |
| 3.5 | 21.9 | 0 | 0 | 0 |
| \| | | | | |
| 9 | | 0.1 | 0.2 | 0.1 |
| 10 | | 1.6 | 1.0 | 2.5 |
| 11 | | 18.4 | 3.9 | 17.3 |
| 11.5 | | 46.2 | 6.4 | 32.4 |
| 12 | | | 9.8 | |
| 12.5 | | | 13.4 | |
| 13 | | | 17.7 | |
| 13.5 | | | 24.6 | |

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, the term “about” can include traditional rounding according to the numerical value provided and the technique/system/apparatus used. In addition, the phrase “about ‘x’ to ‘y’” includes “about ‘x’ to about ‘y’”.

It should be emphasized that the above-described embodiments of the present disclosure are merely possible examples of implementations, and are merely set forth for a clear understanding of the principles of this disclosure. Many variations and modifications may be made to the above-described embodiment(s) of the disclosure without departing substantially from the spirit and principles of the disclosure. All such modifications and variations are intended to be included herein within the scope of this disclosure and protected by the following claims.

We claim at least the following:

1. A method of reducing calcium carbonate and calcium sulfate scale in a desalination system, comprising:
disposing a composition in an aqueous solution in the desalination system, wherein the composition includes an active substance that is a carboxylated polymer that has been neutralized with an organic amine; and
inhibiting the formation of a scale on the one or more surfaces of the desalination system, wherein the scale is selected from the group consisting of calcium carbonate, calcium sulfate, and a combination thereof.

2. The method of claim 1, wherein the composition is at least 50% biodegradable over a time period of about 28 days.

3. The method of claim 1, wherein the carboxylated polymer is selected from the group consisting of: a polyacrylic acid homopolymer, a polyacrylic acid copolymer, a maleic acid homopolymer, and a combination thereof.

4. The method of claim 1, wherein the carboxylated polymer is a polyacrylic acid homopolymer or a polyacrylic acid copolymer.

5. The method of claim 1, wherein the neutralized carboxylated polymer is in an aqueous solution having a pH at least 6.0.

6. The method of claim 4, wherein the amount of acrylic acid in the polyacrylic acid copolymer is greater than about 70 mol %.

7. The method of claim 4, wherein the amount of acrylic acid in the polyacrylic acid copolymer is greater than about 85 mol %.

8. The method of claim 4, wherein the amount of acrylic acid in the polyacrylic acid copolymer is greater than about 95 mol %.

9. The method of claim 1, wherein the desalination system is a reverse osmosis desalination system.

10. The method of claim 1, wherein the active substance of the composition is added to the water system is about 0.5 part per million to 50 parts per million.

11. The method of claim 1, wherein the organic amine is an amino alcohol.

12. The method of claim 11, wherein the amino alcohol is selected from the group consisting of: monoethanolamine, diethanolamine, monoisopropanolamine, and a combination thereof.

13. The method of claim 12, wherein the amino alcohol is monoethanolamine.

14. The method of claim 1, wherein the organic amine is selected from the group consisting of: an amino alcohol, a primary amine, a secondary amine, a tertiary amine, and a combination thereof.

15. The method of claim 1, wherein the carboxylated polymer that has been neutralized with an organic amine is a polyacrylic acid homopolymer that has been neutralized with a monoethanolamine.
